(19) United States
(12) Patent Application Publication
(10) Pub. No.: US 2023/0326125 A1
(43) Pub. Date: Oct. 12, 2023

(54) IMAGE PROCESSING SYSTEM FOR CONVERTING 2D IMAGES INTO 3D MODEL AND METHOD THEREOF

(71) Applicant: SPEED 3D Inc., Taipei City (TW)

(72) Inventors: Li-Chuan Chiu, Taipei City (TW); Jui-Chun Chung, Taipei City (TW); Yi-Ping Cheng, Taipei City (TW)

(73) Assignee: SPEED 3D Inc., Taipei City (TW)

(21) Appl. No.: 17/884,587

(22) Filed: Aug. 10, 2022

(30) Foreign Application Priority Data
Apr. 7, 2022 (TW) 111113603

(51) Int. Cl. G06T 17/00; G06T 15/20; G06V 20/64

(52) U.S. Cl. CPC G06T 17/00; G06T 15/205; G06V 20/647

(57) ABSTRACT

An image processing system for converting 2D images into 3D model includes a selecting model, an asset importing module, a converting module and a model generating module. The selecting model receives a category selecting instruction to select an object category and receives a template selecting instruction to select an object template corresponding to the object category. The asset importing module receives a plurality of 2D views of a target object in different view angles. The converting module projects the 2D views to the object template to generate a projected image. The model generating module amends the projected image to generate a 3D model.

### BACKGROUND OF THE INVENTION

### 1. Field of the Invention

The present invention relates to an image processing system, in particular to an image processing system for converting two-dimensional (2D) images into three-dimensional (3D) model. The present invention further relates to the method of the image processing system.

### 2. Description of the Prior Art

Metaverse is an on-line 3D virtual environment based on decentralization. A user can enter an artificial virtual world via a virtual reality (VR) headset, augmented reality (AR) headset or an electronic device (e.g., a smart phone, a tablet computer, a personal computer, etc.). Many product providers need to manufacture a large amount of 3D models of various products to achieve the desired AR effects in order to conform to the development trend of metaverse in the future. However, it may take several engineers a few hours to manufacture the 3D model of a product, which significantly increases the time cost and the manufacturing cost. Accordingly, currently available technologies cannot satisfy the actual requirements.

### SUMMARY OF THE INVENTION

One embodiment of the present invention provides an image processing system for converting two-dimensional (2D) images into three-dimensional (3D) model, which includes a selecting model, an asset importing module, a converting module and a model generating module. The selecting model receives a category selecting instruction to select an object category and receives a template selecting instruction to select an object template corresponding to the object category. The asset importing module receives a plurality of 2D views of a target object in different view angles. The converting module projects the 2D views to the object template to generate a projected image. The model generating module amends the projected image to generate a 3D model.

In one embodiment, the model generating module performs one or more of compressing, trimming and dislocation adjustment to process the projected image in order to generate the 3D model.

In one embodiment, the image processing system further includes a preview module and an image capturing model. The image capturing module captures the image of a user. The preview module combines the image of the user with the 3D model to generate a preview image and a network link for accessing the 3D model.

In one embodiment, the packet module converts the 3D model into a packet.

In one embodiment, the image processing system further includes a cloud storage module. The cloud storage module receives the packet transmitted from the packet module and saves the packet.

Another embodiment of the present invention provides an image processing method for converting 2D images into 3D model, which includes the following steps: receiving a category selecting instruction to select an object category and receiving a template selecting instruction to select an object template corresponding to the object category; receiving a plurality of 2D views of a target object in different view angles; projecting the 2D views to the object template to generate a projected image; and amending the projected image to generate a 3D model.

In one embodiment, the step of amending the projected image to generate the 3D model further includes the following step: performing one or more of compressing, trimming and dislocation adjustment to process the projected image in order to generate the 3D model.

In one embodiment, the image processing method further includes the following steps: capturing the image of a user; combining the image of the user with the 3D model to generate a preview image; and generating a network link for accessing the 3D model.

In one embodiment, the image processing method further includes the following steps: converting the 3D model into a packet; and generating a network link for accessing the 3D model.

In one embodiment, the image processing method further includes the following step: transmitting the packet to a cloud storage module and saving the packet in the cloud storage module.

The image processing system for converting 2D images into 3D model and method thereof in accordance with the embodiments of the present invention may have the following advantages:
(1) In one embodiment of the present invention, the image processing system includes the asset importing module, the converting module and the model generating module. The asset importing module can receive the 2D views of the target object in different view angles and the converting module can project the 2D views to the object template to generate the projected image. The model generating module can amend the projected image to generate the 3D model. Via the above image processing mechanism, the image processing system can swiftly generate the 3D models of a large number of different target objects, which can greatly reduce the time cost and the manufacturing cost. Thus, the image processing system can definitely satisfy actual requirements.
(2) In one embodiment of the present invention, the image processing system has the model generating module, which can perform compressing, trimming and dislocation adjustment so as to further optimize the projected image. Therefore, the image processing system can generate the 3D model having the desired visual effects.
(3) In one embodiment of the present invention, the image processing system has the preview module and the image capturing module. The image capturing module can capture the image of the user and the preview module can combine the image of the user with the 3D model to generate the preview image. In this way, the user can determine whether the visual effects of the combination of the 3D model and the image of the user fit in with his/her requirements according to the preview image.
(4) In one embodiment of the present invention, the image processing system includes the packet module and the cloud storage module. The packet module can convert the optimized 3D model into the packet and save the packet in the cloud storage module. Therefore, the user can conveniently access the optimized 3D model via the cloud storage module at any time, so the system can be more convenient in use and more flexible in application.
(5) In one embodiment of the present invention, the image processing system can generate the optimized 3D models for a large amount of target objects in a short time via the specially-designed image processing mechanism. In this way, the system can effectively solve the problems of the currently available technologies. Therefore, the system can achieve high commercial value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is block diagram of an image processing system for converting two-dimensional (2D) images into three-dimensional (3D) model in accordance with one embodiment of the present invention.

FIG. 2 is a first schematic view of an object template of the image processing system for converting 2D images into 3D model in accordance with one embodiment of the present invention.

FIG. 3 is a second schematic view of the object template of the image processing system for converting 2D images into 3D model in accordance with one embodiment of the present invention.

FIG. 4 is a flow chart of an image processing method for converting 2D images into 3D model in accordance with one embodiment of the present invention.

FIG. 5 is a flow chart of an image processing method for converting 2D images into 3D model in accordance with another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

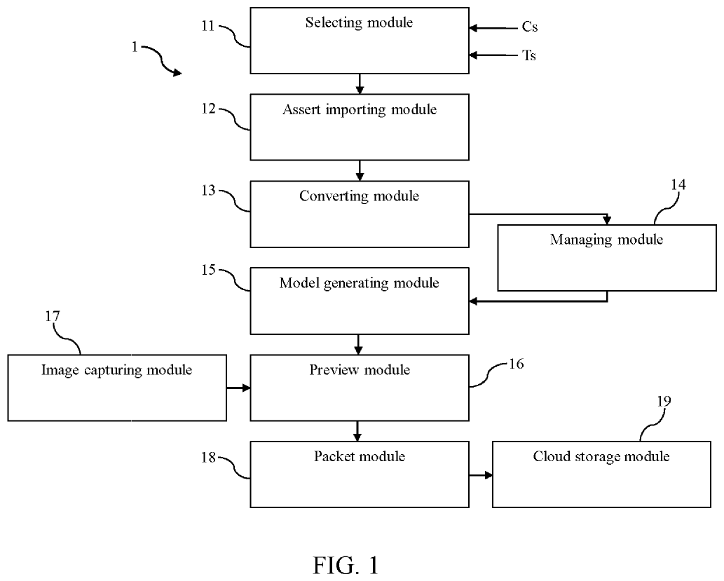

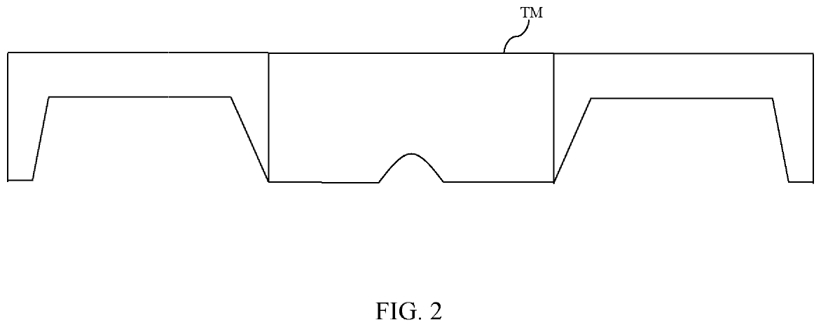

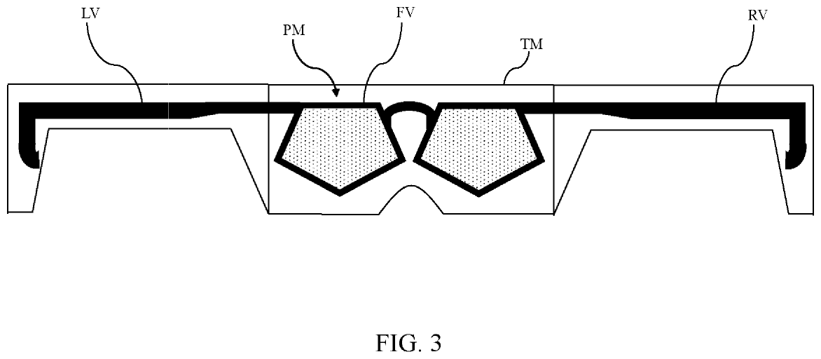

Please refer to FIG. 1, FIG. 2 and FIG. 3. FIG. 1 is block diagram of an image processing system for converting two-dimensional (2D) images into three-dimensional (3D) model in accordance with one embodiment of the present invention. FIG. 2 is a first schematic view of an object template of the image processing system for converting 2D images into 3D model in accordance with one embodiment of the present invention. FIG. 3 is a second schematic view of the object template of the image processing system for converting 2D images into 3D model in accordance with one embodiment of the present invention. As shown in FIG. 1, the image processing system 1 includes a selecting module 11, an asset importing module 12, a converting module 13, a model generating module 15, a managing module 14, a preview module 16, an image capturing module 17, a packet module 18 and a cloud storage module 19.

The selecting module 11 can receive a category selecting instruction Cs to select an object category and receive a template selecting instruction Ts to select an object template TM corresponding to the above object category. The user can transmit the category selecting instruction Cs and the template selecting instruction Ts via his/her electronic device (e.g., a smart phone, a tablet computer, a VR headset, an AR headset, etc.) so as to select the object category (e.g., glasses, earrings, nose ring, makeup, hairstyle, cosmetic lens, various accessories, etc.) and the object template TM corresponding thereto. For instance, if the object category is glasses, the object template TM corresponding thereto may be the sunglasses template, the reading glasses template, the safety googles template, etc. In this embodiment, the object category selected by the user is glasses and the object template TM corresponding thereto is the sunglasses template, as shown in FIG. 2.

As shown in FIG. 1, the asset importing module 12 is connected to the selecting module 11 and receives a plurality of 2D views of a target object in different view angels. In this embodiment, the user can select a pair of sunglasses, which the user would like to exhibit, be the target object. Then, the user can import the 2D views of the target object in different view angles (including the front view FV, the left view LV and the right view RV) into the asset importing module 12 so as to serve as the assets for manufacturing a 3D model. The quantity and the view angels of the 2D views may be different according to the type of the target object.

As shown in FIG. 1 and FIG. 3, the converting module 13 is connected to the asset importing module 12. The converting module 13 can project the 2D views (including the front view FV, the left view LV and the right view RV) to the object template TM by UV mapping with a view to generate a projected image PM formed by combining the 2D images with each other.

As shown in FIG. 1, the managing module 14 is connected to the converting module 13. The system administrator (the person in charge of managing and maintaining the image processing system 1) can confirm whether the characteristics of the projected image PM conform to the predetermined format, such as file type, file size, etc., via the managing module 14. If the characteristics of the projected image PM fail to conform to the predetermined format, the system administrator can discard the projected image PM and ask the user to re-import the 2D views into the asset importing module 12 and then repeat the above steps. The system administrator can connect his/her electronic device (e.g., a smart phone, a tablet computer, a personal computer, etc.) to the image processing system 1 in order to execute the above operation via the managing module 14. In another embodiment, the electronic device of the system administrator may be the managing module 14.

The model generating module 15 is connected to the managing module 14. If the characteristics of the projected image PM conform to the predetermined format, the system administrator can transmit the projected image PM to the model generating module 15 via the managing module 14. Afterward, the model generating module 15 can amend the projected image PM (e.g., compressing, trimming, dislocation adjustment, etc.) so as to further optimize the projected image PM and convert the projected image PM into a 3D model.

The preview module 16 is connected to the model generating module 15 and the image capturing module 17 is connected to the preview module 16. The image capturing module 17 can capture the image of the user and the user can upload his/her image to the image capturing module 17 via his/her electronic device. In another embodiment, the image capturing module 17 (e.g., an analog camera, a digital camera, etc.) can directly capture the image of the user. Then, the preview module 16 can combine the image of the user with the 3D model in order to generate a preview image. Next, the user can determine whether the visual effects of the 3D model conform to his/her requirements. If the visual effects of the 3D model cannot satisfy the user's requirements, the user can direct discard the projected image PM. Afterward, the user can re-import the 2D views into the asset importing module 12 and then repeat the above steps.

The packet module 18 is connected to the preview module 16 and the cloud storage module 19 is connected to the packet module 18. If the visual effects of the 3D model conform to the user's requirements, the user can save the 3D model in the packet module 18. Afterward, the packet module 18 can convert the 3D model into a packet and transmit the packet to the cloud storage module 19 with an aim of saving the packet in the cloud storage module 19. Meanwhile, the preview module 16 can generate a network link for accessing the 3D module. The user can transmit the network link to the electronic device (e.g., a smart phone, a tablet computer, a personal computer, etc.) of a potential customer. In this way, the customer can click the network link via his/her electronic device to trigger the network link (the customer can also trigger the network link via other similar means). After the network link has been triggered, the electronic device of the customer can obtain the 3D model from the cloud storage module 19 and capture the image of the customer via the camera thereof. Next, the electronic device of the customer can combine the image of the customer with the 3D model, such that the customer can watch the preview image of wearing the 3D model (e.g., the 3D model of a pair of sunglasses). The above steps can be directly finished by the browser of the customer's electronic device without any additional software. Via the above mechanism, the user can manufacture the 3D models of a large amount of different target objects in a short time and save which in the cloud storage module 19. Accordingly, the user can access the 3D models via the cloud storage module 19 at any time, which can be more convenient in use.

Via the above mechanism, the image processing system 1 can manufacture the 3D models of a large number of different target objects in a short time. Thus, the image processing system 1 not only can obtain the 3D models having great visual effects, but also can greatly reduce the time cost and the manufacturing cost. Thus, the image processing system 1 can definitely meet actual requirements.

Moreover, the image processing system 1 can perform one or more of compressing, trimming and dislocation adjustment (adjusting the positions of the front view FV, the left view LV and the right view RV to make the combination of which match the object template TM) in order to further optimize the projected image PM. Thus, the image processing system 1 can manufacture the 3D models having excellent visual effects. Further, the image processing system 1 can also provide the preview function to combine the image of the user with a 3D model to generate a preview image, so the user can determine whether the visual effects of the 3D model combined with the image of the user conform to his/her requirements according to the preview image in order to take the necessary measures in time.

The embodiment just exemplifies the present invention and is not intended to limit the scope of the present invention; any equivalent modification and variation according to the spirit of the present invention is to be also included within the scope of the following claims and their equivalents.

It is worthy to point out that it may take several engineers a few hours to manufacture the 3D model of a product, which significantly increases the time cost and the manufacturing cost. Accordingly, currently available technologies cannot satisfy the actual requirements. On the contrary, according to one embodiment of the present invention. the image processing system includes the asset importing module, the converting module and the model generating module. The asset importing module can receive the 2D views of the target object in different view angles and the converting module can project the 2D views to the object template to generate the projected image. The model generating module can amend the projected image to generate the 3D model. Via the above image processing mechanism, the image processing system can swiftly generate the 3D models of a large number of different target objects, which can greatly reduce the time cost and the manufacturing cost. Thus, the image processing system can definitely satisfy actual requirements.

Also, according to one embodiment of the present invention, the image processing system has the model generating module, which can perform compressing, trimming and dislocation adjustment so as to further optimize the projected image. Therefore, the image processing system can generate the 3D model having the desired visual effects.

Further, according to one embodiment of the present invention, the image processing system has the preview module and the image capturing module. The image capturing module can capture the image of the user and the preview module can combine the image of the user with the 3D model to generate the preview image. In this way, the user can determine whether the visual effects of the combination of the 3D model and the image of the user fit in with his/her requirements according to the preview image.

Moreover, according to one embodiment of the present invention, the image processing system includes the packet module and the cloud storage module. The packet module can convert the optimized 3D model into the packet and save the packet in the cloud storage module. Therefore, the user can conveniently access the optimized 3D model via the cloud storage module at any time, so the system can be more convenient in use and more flexible in application.

Furthermore, according to one embodiment of the present invention, the image processing system can generate the optimized 3D models for a large amount of target objects in a short time via the specially-designed image processing mechanism. In this way, the system can effectively solve the problems of the currently available technologies. Therefore, the system can achieve high commercial value. As set forth above, the image processing system according to the embodiments of the present invention can definitely achieve great technical effects.

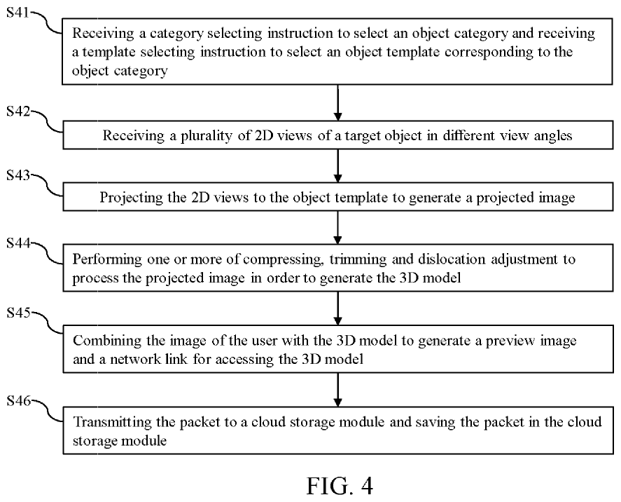

Please refer to FIG. 4, which is a flow chart of an image processing method for converting 2D images into 3D model in accordance with one embodiment of the present invention. As shown in FIG. 4, the image processing method according to this embodiment of the present invention includes the following steps:

Step S41: receiving a category selecting instruction to select an object category and receiving a template selecting instruction to select an object template corresponding to the object category.

Step S42: receiving a plurality of 2D views of a target object in different view angles.

Step S43: projecting the 2D views to the object template to generate a projected image.

Step S44: performing one or more of compressing, trimming and dislocation adjustment to process the projected image in order to generate the 3D model.

Step S45: combining the image of the user with the 3D model to generate a preview image and a network link for accessing the 3D model.

Step S46: transmitting the packet to a cloud storage module and saving the packet in the cloud storage module.

The embodiment just exemplifies the present invention and is not intended to limit the scope of the present invention; any equivalent modification and variation according to the spirit of the present invention is to be also included within the scope of the following claims and their equivalents.

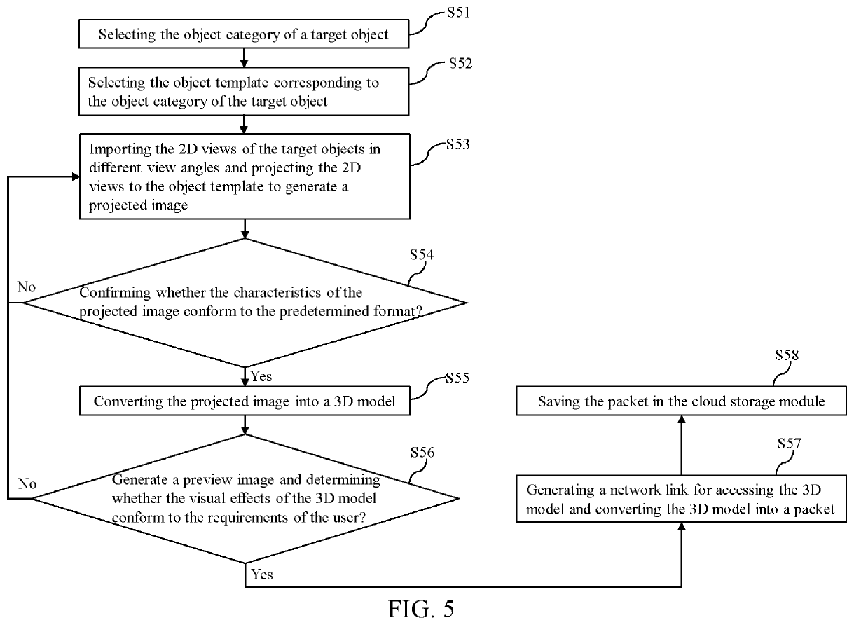

Please refer to FIG. 5, which is a flow chart of an image processing method for converting 2D images into 3D model in accordance with another embodiment of the present invention. FIG. 5 illustrates the details of the steps of the image processing method.

Step S51: selecting the object category of a target object; then, the process proceeds to Step S52.

Step S52: selecting the object template corresponding to the object category of the target object; then, the process proceeds to Step S53.

Step S53: importing the 2D views of the target objects in different view angles and projecting the 2D views to the object template to generate a projected image; then, the process proceeds to Step S54.

Step S54: confirming whether the characteristics of the projected image conform to the predetermined format? If they do, the process proceeds to Step S55; if they do not, the process returns to Step S53.

Step S55: amending the projected image and converting the projected image into a 3D model; then, the process proceeds to Step S56.

Step S56: combining the image of a user with the 3D model to generate a preview image and determining whether the visual effects of the 3D model conform to the requirements of the user? If they do, the process proceeds to Step S57; if they do not, the process returns to Step S53.

Step S57: generating a network link for accessing the 3D model and converting the 3D model into a packet; then, the process proceeds to Step S58.

Step S58: transmitting the packet to a cloud storage module and saving the packet in the cloud storage module.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the present invention, the image processing system includes the asset importing module, the converting module and the model generating module. The asset importing module can receive the 2D views of the target object in different view angles and the converting module can project the 2D views to the object template to generate the projected image. The model generating module can amend the projected image to generate the 3D model. Via the above image processing mechanism, the image processing system can swiftly generate the 3D models of a large number of different target objects, which can greatly reduce the time cost and the manufacturing cost. Thus, the image processing system can definitely satisfy actual requirements.

Also, according to one embodiment of the present invention, the image processing system has the model generating module, which can perform compressing, trimming and dislocation adjustment so as to further optimize the projected image. Therefore, the image processing system can generate the 3D model having the desired visual effects.

Further, according to one embodiment of the present invention, the image processing system has the preview module and the image capturing module. The image capturing module can capture the image of the user and the preview module can combine the image of the user with the 3D model to generate the preview image. In this way, the user can determine whether the visual effects of the combination of the 3D model and the image of the user fit in with his/her requirements according to the preview image.

Moreover, according to one embodiment of the present invention, the image processing system includes the packet module and the cloud storage module. The packet module can convert the optimized 3D model into the packet and save the packet in the cloud storage module. Therefore, the user can conveniently access the optimized 3D model via the cloud storage module at any time, so the system can be more convenient in use and more flexible in application.

It should also be noted that at least some of the operations for the methods described herein may be implemented using software instructions stored on a computer useable storage medium for execution by a computer (or a processor). As an example, an embodiment of a computer program product includes a computer useable storage medium to store a computer readable program.

The computer useable or computer readable storage medium can be an electronic, magnetic, optical, electromagnetic, infrared, or semiconductor system (or apparatus or device). Examples of non-transitory computer useable and computer readable storage media include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention (or each module of the system) may be implemented entirely in hardware, entirely in software or in an implementation containing both hardware and software elements. In embodiments which use software, the software may include, but not limited to, firmware, resident software, microcode, etc. In embodiments which use hardware, the hardware may be implemented within one or more application specific integrated circuits (ASICs), digital signal processors (DSPs), digital signal processing devices (DSPDs), programmable logic devices (PLDs), field programmable gate arrays (FPGAs), central-processing unit (CPU), controllers, micro-controllers, microprocessors, electronic devices, other electronic units designed to perform the functions described herein, or a combination thereof.

Furthermore, according to one embodiment of the present invention, the image processing system can generate the optimized 3D models for a large amount of target objects in a short time via the specially-designed image processing mechanism. In this way, the system can effectively solve the problems of the currently available technologies. Therefore, the system can achieve high commercial value.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing system for converting two-dimensional (2D) images into three-dimensional (3D) model, comprising:
a selecting model configured to receive a category selecting instruction to select an object category and receive a template selecting instruction to select an object template corresponding to the object category;
an asset importing module configured to receive a plurality of 2D views of a target object in different view angles;
a converting module configured to project the 2D views to the object template to generate a projected image; and
a model generating module configured to amend the projected image to generate a 3D model.

2. The image processing system for converting 2D images into 3D model as claimed in claim 1, wherein the model generating module is configured to perform one or more of compressing, trimming and dislocation adjustment to process the projected image in order to generate the 3D model.

3. The image processing system for converting 2D images into 3D model as claimed in claim 1, further comprising a preview module and an image capturing model, wherein the image capturing module is configured to capture an image of a user and the preview module is configured to combine the image of the user with the 3D model to generate a preview image and a network link configured to access the 3D model.

4. The image processing system for converting 2D images into 3D model as claimed in claim 1, further comprising a packet module configured to convert the 3D model into a packet.

5. The image processing system for converting 2D images into 3D model as claimed in claim 4, further comprising a cloud storage module configured to receive the packet transmitted from the packet module and saves the packet.

6. An image processing method for converting 2D images into 3D model, comprising:
receiving a category selecting instruction to select an object category and receiving a template selecting instruction to select an object template corresponding to the object category;
receiving a plurality of 2D views of a target object in different view angles;
projecting the 2D views to the object template to generate a projected image; and
amending the projected image to generate a 3D model.

7. The image processing method for converting 2D images into 3D model as claimed in claim 6, wherein a step of amending the projected image to generate the 3D model comprises:
performing one or more of compressing, trimming and dislocation adjustment to process the projected image in order to generate the 3D model.

8. The image processing method for converting 2D images into 3D model as claimed in claim 6, further comprising:
capturing an image of a user;
combining the image of the user with the 3D model to generate a preview image; and
generating a network link configured to access the 3D model.

9. The image processing method for converting 2D images into 3D model as claimed in claim 6, further comprising:
converting the 3D model into a packet; and
generating a network link configured to access the 3D model.

10. The image processing method for converting 2D images into 3D model as claimed in claim 9, further comprising:
transmitting the packet to a cloud storage module and saving the packet in the cloud storage module.
